(19) United States
(12) Patent Application Publication
(10) Pub. No.: US 2022/0055775 A1
(43) Pub. Date: Feb. 24, 2022

(54) ORBITAL ARTIFICIAL REENTRY CORRIDOR

(71) Applicant: Geoffrey T. SHEERIN, Sarnia (CA)

(72) Inventor: Geoffrey T. SHEERIN, Sarnia (CA)

(21) Appl. No.: 17/414,613

(22) PCT Filed: Dec. 19, 2019
(86) PCT No.: PCT/IB2019/001344

§ 371 Date: Jun. 16, 2021

Related U.S. Application Data
(60) Provisional application No. 62/782,025, filed on Dec. 19, 2018.

(51) Int. Cl. B64G 1/62; B64G 1/66

(52) U.S. Cl. CPC B64G 1/62; B64G 1/66

(57) ABSTRACT

A method for creating an artificial reentry corridor. Several modules are deployed in a retrograde orbit relative to target debris. Each module releases a gas plume which, in turn creates an artificial reentry corridor. The debris passes through the corridor and becomes decelerated.

### CROSS-REFERENCE TO RELATED APPLICATIONS

This application claims priority to and is a non-provisional of U.S. Patent Application 62/782,025 (filed Dec. 19, 2018), the entirety of which is incorporated herein by reference.

### BACKGROUND OF THE INVENTION

Humans have polluted oceans and rivers until they have become almost unusable. The same has been done with orbital space. Debris has been left in orbit that hurtles around the Earth at extreme speeds. Orbital debris could impact 7 billion human lives around the globe.

In 1978, NASA scientist Donald J. Kessler demonstrated the danger represented by the decaying of man-made space objects in orbit around Earth. This presence of space debris has been considered an acceptable risk, considering the low probability of collision (the Big Sky theory). However, the ever-expanding activity of humans in space has skyrocketed the number of debris to such an extent that the Big Sky theory is no longer valid. The 2009 the Cosmos/Iridium satellites collision proved that the Kessler syndrome was not just an unlikely scenario. Scientists now fear that a new collision could cause a cascade of other collisions, denying humans access to space.

Though mitigation policies are being put in place, it appears that the only sustainable solution would be to actively clean the near-Earth orbits. For the last decade, political, economic and legal obstacles have been slowing down the implementation of space debris removal. New initiatives in the fields of law, politics, industry and economical thinking are putting space cleaning under a new light. The development of such responsible activity seems to be possible as new ideas and geopolitical trends are evolving.

Most of the objects are less than 1 cm (0.39 inches) in diameter. This also includes dust from solid rocket motors, paint chips and other small debris that flaked from satellite systems. Many systems that include nets, large sails and other structures are only effective for objects that can be grasped and provide poor capture of on-orbit debris for subsequent de-orbit and, indeed, can be damaged by other impacts, contributing to the debris problem on orbit. An improved method is therefore desired.

The discussion above is merely provided for general background information and is not intended to be used as an aid in determining the scope of the claimed subject matter.

### SUMMARY

A method for creating an artificial reentry corridor. Several modules are deployed in a retrograde orbit relative to target debris. Each module releases a gas plume which, in turn creates an artificial reentry corridor. The debris passes through the corridor and becomes decelerated.

In a first embodiment, a method for creating an artificial reentry corridor is provided. The method comprising steps of deploying a plurality of orbital modules in series in a first orbital pathway, wherein the first orbital pathway is retrograde relative to a second orbital pathway of an orbital debris, wherein the first orbital pathway is parallel to the second orbital pathway; releasing a gas plume from each orbital module in the series of orbital modules, thereby creating an artificial reentry corridor consisting of the gas plume, wherein the gas plume expands over time such that the artificial reentry corridor overlaps with the second orbital pathway of the orbital debris; and allowing the orbital debris to pass through the artificial reentry corridor and thereby decelerate.

In a second embodiment, an orbital module is provided. The orbital module comprising: a housing with at least one axis of symmetry; a storage tank disposed within the housing, the storage tank storing a fluid; a plurality of nozzles symmetrically disposed about the axis of symmetry, wherein each nozzle is fluidly connected to the storage tank; and a wireless receiver and a computer processor, the computer processor operatively configured to actuate a valve that releases the fluid from the storage tank thereby providing the fluid to each nozzle.

This brief description of the invention is intended only to provide a brief overview of subject matter disclosed herein according to one or more illustrative embodiments and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a depiction of a module deployment corridor;

FIG. 2 is a depiction of an ARC module; and

FIG. 3A is a depiction of debris impacting a series of gas plumes;

FIG. 3B depicts the formation of a single gas plume;

FIG. 3C shows debris as it is about to leave one gas plume and enter another gas plume.

### DETAILED DESCRIPTION OF THE INVENTION

The present disclosure provides a corridor of high density gas along the path of an orbiting debris to facilitate either vaporization of the debris (in the same manner as atmosphere reentry) or deceleration due to drag in order to put the debris on a path that intersects the Earth's atmosphere for safe disposal. The disclosed system can use a variety of fluids (i.e. a gas or a liquid that vaporize to form the gas) that will evaporate or sublimate into space but, for a very short while, will provide a high-density corridor of gas through which space debris will pass. In one embodiment, the system is deployed in a retrograde direction relative to the space debris' orbital path. Due to the conflicting rotary paths, the gas molecules hit the object at an increased velocity (e.g. 10 miles per second).

The disclosure addresses problems of fracture and dispersal of debris along an orbital path. Many other systems proposed to decelerate and remove orbital debris have a difficult time dealing with small parts and components of the debris. This disclosure addresses that problem by using a brief, high density gas that mimics reentry at high altitude and, using retrograde orbits of gas molecules, mimics reentry from planetary mission velocity.

A method of producing an artificial deceleration corridor for the purpose of removal of orbital space debris is disclosed. A carrier spacecraft is launched into a retrograde orbit on the same path as the target debris. The carrier spacecraft deploys a plurality of modules (e.g. a fleet of modules), one after another; so that they form a row of modules spaced a few thousand feet (e.g. 100 meters to 900 meters) apart for several miles (e.g. 2-32 km) along the orbital path of the target debris, but in a retrograde in direction. The modules are deployed in an orbital pathway that is parallel to the orbital pathway of the debris but spaced therefrom by a predetermined distance (e.g. 60 meters to 100 meters).

Each module contains compressed fluid (i.e. a gas or a liquid that vaporizes to form a gas) that is released through nozzles to generate an expanding plume of gas. In one embodiment, there are multiple nozzles that are positioned circumferentially about the module. When the debris is at a pre-determined distance from the lead module (i.e. the first module in the series of modules that will be encountered by the debris), the valves are remotely opened to deploy the compressed fluid into the surrounding vacuum, allowing the gas to expand a short distance and intercept the debris in a retrograde orbital direction. The remote opening can be controlled, for example, by wireless signals sent from the carrier spacecraft.

The row of modules is sequentially or simultaneously triggered by wireless command so the debris flies through one or more gas plumes for several. This results in an artificially created reentry corridor at altitude, causing the debris to be either vaporized or decelerated until it reenters the earth atmosphere. Once the debris has passed through the gas sphere, the gas will continue to expand until it dissipates to a concentration that is harmless to other objects orbiting in the vicinity. If the debris has not been decelerated enough or completely destroyed, subsequent deployments can be performed later on the antipodal side of the planet. This can be done repeatedly, as long as gas supplies last in the modules. Once the module gas is depleted or the targeting mission is complete, modules are returned to the carrier spacecraft for de-orbit into a safe splashdown area.

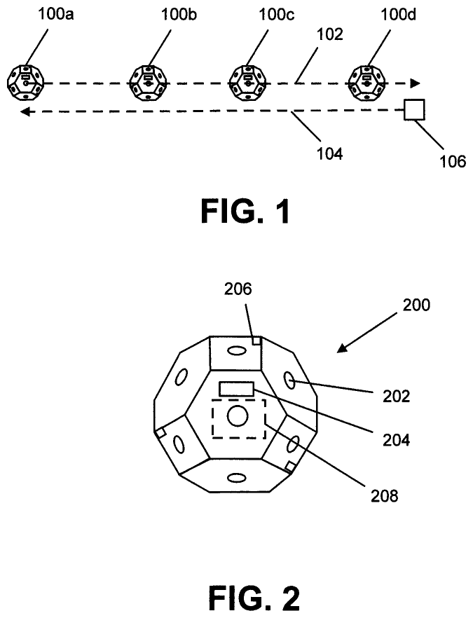

FIG. 1 shows the placement of modules 100a, 100b, 100c and 100d along a orbit pathway 102 that is parallel to an orbital pathway 104 of a target debris 106. The gas is released into the vacuum of space becoming part of an expanding sphere of gas. The closing rate between the gas plume and the debris at low Earth orbit is about 10 miles per second (16 km per second) and, because the expansion rate of the gas plume is a function of the temperature of the gas, one can generally assume an expansion rate of 2000 ft per second (610 meters per seconds).

In one embodiment, each module is tethered to at least one adjacent module by a cable. In one such embodiment, each module is tethered to one, and only one, adjacent module (i.e. modules in the fleet are tethered in pairs). In one embodiment, the modules are independent spacecraft as shown in FIG. 2. In the embodiment of FIG. 2, each module 200 has a polyhedral housing but other suitable housings would be apparent to those skill in the art after benefitting from reading this specification In the embodiment of FIG. 2, the polyhedral housing consists of square planar faces and hexagonal planar faces arranged to form a round housing. Each module 200 has at least one nozzle 202 that is fluidly connected to a storage tank 208 that holds the fluid for subsequent release. In some embodiment, the module has at least one axis of symmetry, wherein the nozzles are symmetrically distributed about this axis, thereby releasing the gas in an omnidirectional fashion. In another embodiment, the nozzles are asymmetrically distributed, thereby releasing the gas in a directional fashion. In the embodiment of FIG. 2, a plurality of gas nozzles 202 are provided which are symmetrically distributed over the surface of the module 200. This symmetry promotes the formation of a symmetrical gas plume. In other embodiments (e.g. a cylinder) there is a single axis of symmetry and the nozzles are symmetrically distributed about this axis. In one embodiment, the storage tank 208 is opened at a single valve that provides fluids to each of the gas nozzles 202. The module 200 also comprises a wireless receiver 204 for receiving wireless signals that operation the nozzle(s) 202 and/or valve. A processor is also present for processing the wireless signal and actuating the nozzles(s). In some embodiments, one or more thrusters 206 are present that enable the module 200 to be moved after the module 200 has been deployed from the carrier spacecraft. This can aid in repositioning of the module prior to or during use and/or recovery of the module after use.

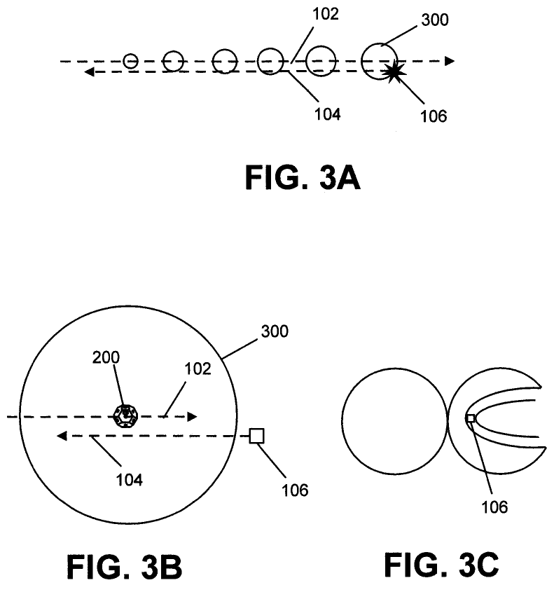

Because the debris can be tracked within 1000 ft (305 meters) of its path, then modules will be placed a few thousand feet apart so that the orbital debris enters at least one gas plume almost continuously, with the density of the gas similar to the upper atmosphere at 300,000 ft. (91,440 feet) The gas becomes ionized upon impact with the surface of the debris causing heating and erosion of the surface of the debris. In one embodiment, a short corridor is created by deploying a few (e.g. ten or more) modules. Because the majority of small meteors burn in the upper atmosphere at an altitude of 60 miles (97 km) in just a few seconds the corridor may be a total of 20 miles (32 km) long to enable most small debris to burn. If each gas bubble is 2000 ft (610 meters) in diameter then only seventy modules need be deployed to make the entire system spread out over 20 (32 km) miles in length to decelerate and vaporize small debris as shown in FIG. 3.

FIG. 3A depicts several gas plumes 300 that have been sequentially triggered. The debris 106 has impacted the lead gas plume. A short time later, the debris 106 will impact the second gas plume in the series, by which time all of the gas plumes have further expanded in diameter. FIG. 3A depicts six plumes for simplicity of illustration.

FIG. 3B depicts a gas plume 300 being formed from the module 200. Due to the symmetrical distribution of the nozzles, the gas plume 300 is symmetrical. FIG. 3C depicts debris 106 after it has encountered a first gas plume and is about to enter a second gas plume. In the embodiment of FIG. 3B, the two gas plumes are congruent are effectively form a single, interconnected gas plume. In other embodiments, the gas plumes are not congruent and form sequential gas plumes that are separated from one another by the vacuum of space.

Different combinations of gas and or liquids can be used to fine tune the system in order to accommodate large and small objects. Examples of suitable fluids include argon, carbon dioxide, nitrogen and oxygen. In one embodiment, the fluid is water. Larger objects can be decelerated so their orbit intersects the atmosphere where final reentry occurs, while smaller objects are vaporized in the artificial reentry corridor of the expanding gas. Within a few seconds, the gas pulse expands to a density that is low enough that is has no further impact on other orbital bodies. In one embodiment, a corridor is established in the same location every orbit so that every 45 minutes a deceleration pulse is felt by the orbital debris as the debris repeatedly passes through the same corridor.

In one embodiment, each module is configured to release between 300 kg and 1200 kg of fluid over a one second to four second time period. In those embodiments where all of the fluid is released in a single pass, a gas density of between 10⁻³ and 10⁻⁴ kg per cubic meter is initially produced in the target zone. A computer simulation was conducted wherein the target zone between 30 and 40 meters in front of the debris and the fluid was released 0.1 seconds before the debris entered the target zone.

In another embodiment, a portion of the fluid (e.g. 50-60 kg) was released on each orbital pass of the debris. This iterative release of portions of the fluid was repeated on each pass of the debris. The debris decelerated on each sequential pass as additional 50-60 kg portions were released.

The disclosed system terminates its effects at the atmosphere where normal reentry of debris takes place. The present disclosure brings an artificial atmosphere up to the altitude of the debris using the same gas plasma dynamics found during atmospheric reentry of the debris.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for creating an artificial reentry corridor, the method comprising steps of;
deploying a plurality of orbital modules in series in a first orbital pathway, wherein the first orbital pathway is retrograde relative to a second orbital pathway of an orbital debris, wherein the first orbital pathway is parallel to the second orbital pathway;
releasing a gas plume from each orbital module in the series of orbital modules, thereby creating an artificial reentry corridor consisting of the gas plume, wherein the gas plume expands over time such that the artificial reentry corridor overlaps with the second orbital pathway of the orbital debris; and
allowing the orbital debris to pass through the artificial reentry corridor and thereby decelerate.

2. The method as recited in claim 1, wherein the gas plume is a spherical gas plume.

3. The method as recited in claim 1, wherein each orbital module in the plurality of orbital modules is spaced from adjacent orbital modules by a distance of at least 60 meters and less than or equal to 100 meters.

4. The method as recited in claim 1, wherein the step of releasing the gas plume releases at least 300 kg of a gas.

5. The method as recited in claim 1, wherein the step of releasing the gas plume releases between 300 kg and 1200 kg of a gas.

6. The method as recited in claim 1, wherein the step of releasing the gas plume releases at least 50 kg of a gas.

7. The method as recited in claim 1, wherein the step of releasing the gas plume releases between 50 kg and 60 kg of a gas.

8. The method as recited in claim 7, further comprising:
waiting for the orbital debris to make an orbital pass around Earth;
releasing a second gas plume from each orbital module in the series of orbital modules, thereby creating a second artificial reentry corridor consisting of the second gas plume, wherein the second gas plume expands over time such that the second artificial reentry corridor overlaps with the second orbital pathway of the orbital debris;
allowing the orbital debris to pass through the second artificial reentry corridor and thereby decelerate.

9. The method as recited in claim 8, wherein the step of deploying deploys at least ten modules, each separated from adjacent modules by a distance of at least 60 meters and less than or equal to 100 meters.

10. The method as recited in claim 1, wherein the step of deploying deploys at least ten modules.

11. The method as recited in claim 10, wherein the step of releasing sequentially releases the gas plume from each orbital module.

12. The method as recited in claim 1, wherein the step of deploying deploys at least ten modules but seventy or fewer modules.

13. The method as recited in claim 1, wherein the step of releasing sequentially releases the gas plume from each orbital module.

14. An orbital module comprising:
a housing with at least one axis of symmetry;
a storage tank disposed within the housing, the storage tank storing a fluid;
a plurality of nozzles symmetrically disposed about the axis of symmetry, wherein each nozzle is fluidly connected to the storage tank; and
a wireless receiver and a computer processor, the computer processor operatively configured to actuate a valve that releases the fluid from the storage tank thereby providing the fluid to each nozzle.
